(19) United States
(12) Patent Application Publication
(10) Pub. No.: US 2008/0228500 A1
(43) Pub. Date: Sep. 18, 2008

(54) METHOD AND APPARATUS FOR ENCODING/DECODING AUDIO SIGNAL CONTAINING NOISE AT LOW BIT RATE

(75) Inventors: Jae-one Oh, Yongin-si (KR); Geon-hyoung Lee, Hwanseong-si (KR); Chul-woo Lee, Suwon-si (KR); Jong-hoon Jeong, Suwon-si (KR); Nam-suk Lee, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/015,698

(22) Filed: Jan. 17, 2008

(30) Foreign Application Priority Data
Mar. 14, 2007 (KR) 10-2007-0025135

(51) Int. Cl. G10L 19/00

(52) U.S. Cl. 704/500; 704/E19.001

(57) ABSTRACT

A method and apparatus for encoding/decoding audio signals at a low bit rate are provided. The encoding apparatus selectively encodes one or more reference samples having the highest amplitudes among frequency samples of an audio signal, determines amplitudes of the remaining samples other than the reference sample according to a predetermined pattern, using a predetermined random function, and then encodes the remaining samples using random function input information for causing the same pattern to be generated using the same random function, thus maximizing an encoding rate for an audio signal having a large amount of noise.

### CROSS-REFERENCE TO RELATED PATENT APPLICATION

This application claims priority from Korean Patent Application No. 10-2007-0025135, filed on Mar. 14, 2007 in the Korean Intellectual Property Office, the disclosure of which is incorporated herein in its entirety by reference.

### BACKGROUND OF THE INVENTION

1. Field of the Invention

Methods and apparatuses consistent with the present invention relate to encoding/decoding audio signals, and more particularly, to encoding/decoding audio signals containing noise at a low bit rate.

2. Description of the Related Art

In the related art, most existing high quality audio encoding apparatuses use time-frequency transform coding. This method encodes coefficients obtained by transforming an input audio signal into the frequency domain using a transformation method such as Modified Discrete Cosine Transform (MDCT). However, the sound quality deteriorates as the target bit rate drops, and it is difficult to code audio signals at a low bit rate.

Parametric coding can be used to encode audio signals at a low bit rate. Examples of parametric coding are Harmonic and Individual Lines plus Noise (HINL), and Sinusoidal Coding (SSC). In parametric coding, an original audio signal is assumed to comprise component signals, each having a specific characteristic. The component signals are detected from the original audio signal, and a parameter representing the characteristic of the component signals is encoded. For example, if an audio signal includes a plurality of sinusoidal waves, by encoding only the frequencies, phases, and amplitudes of the sinusoidal waves, the audio signal can be encoded at a low bit rate.

FIG. 1 is a block diagram of a related art parametric coding apparatus. Here, it is assumed that an audio signal includes a transient signal, a sinusoidal signal, and noise. If a pulse-code modulated (PCM) audio signal is received, a transient signal analyzer 110 analyzes a transient signal included in the PCM signal, and generates a transient signal parameter. A quantizer 120 quantizes and encodes the transient signal parameter. A transient signal synthesizer 130 synthesizes a transient signal from the transient signal parameter received from the transient signal analyzer 110, subtracts the synthesized transient signal from the PCM signal, and outputs the result of the subtraction to a sinusoidal wave analyzer 140.

The sinusoidal wave analyzer 140 analyzes a sinusoidal signal included in the received signal, and generates a sinusoidal parameter. A quantizer 150 quantizes and encodes the sinusoidal parameter.

A sinusoidal wave synthesizer 160 synthesizes a sinusoidal signal from the sinusoidal parameter received from the transient signal synthesizer 130, subtracts the synthesized sinusoidal signal from the signal received by the sinusoidal wave analyzer 140, and outputs the result of the subtraction to a noise analyzer 170.

The noise analyzer 170 generates a noise parameter from the received signal. A quantization unit 180 quantizes and encodes the noise parameter received from the noise analyzer 170. A multiplexer 190 multiplexes data of the encoded parameters received from the quantizers 120, 150, and 180, and outputs the result of the multiplexing as a bit stream.

However, the parametric coding method must generate a parameter for each frequency component of an audio signal, and thus has difficulty encoding an audio signal having a large amount of noise at a low bit rate. Since noise includes signal components over nearly all frequency bands, a large number of bits are needed to encode all the signal components.

Also, since all components of noise do not necessarily have important meanings and human's ears do not exactly recognize noise in detail, encoding all frequency components of an audio signal having a large amount of noise includes encoding of unrecognizable noise components, resulting in waste of bandwidth.

### SUMMARY OF THE INVENTION

The present invention provides a method and apparatus for encoding an audio signal at a low bit rate by extracting and encoding a tone component from the audio signal, and generating the remaining components, other than the tone component, through a predetermined random function considering the remaining components as noise, and a method and apparatus for decoding the encoded signal using the predetermined random function.

According to an aspect of the present invention, there is provided a method of encoding an audio signal, including: selecting one or more reference samples including a sample whose amplitude is a maximum of all samples in a frequency band which is an encoding unit; determining amplitudes of the remaining samples other than the reference samples in the frequency band, using a predetermined random function; and encoding the reference samples and the remaining samples whose amplitudes have been determined.

The determining of the amplitudes of the remaining samples includes: determining amplitudes of first type samples which are within a predetermined frequency range from reference samples, using the predetermined random function, to be smaller than a predetermined ratio of the amplitudes of the corresponding reference samples; and determining amplitudes of second type samples that are the remaining samples other than the reference samples or the first type samples, using the predetermined random function, to be smaller than an average of original amplitudes of the second type samples.

In the encoding of the reference samples and the remaining samples, the first type samples are encoded according to information indicating the predetermined ratio and the frequency range, and the second type samples are encoded according to information indicating the average value of the amplitudes of the second type samples.

The predetermined ratio is an average of ratios of the original amplitudes of the first type samples to the amplitude of the corresponding reference samples.

The method further includes: selecting a predetermined number of samples in descending order of amplitude, from among the reference samples and the remaining samples; and generating information regarding phases of the predetermined number of samples, wherein the encoding of the reference samples and the remaining samples is performed according to the information.

The information indicates whether phases of original samples corresponding to the predetermined number of samples are positive (+) or negative (−).

The selecting of the reference samples includes selecting the reference samples in descending order of amplitude, from samples included in the frequency band, and varying the number of reference samples that are to be selected according to a bit rate.

The selecting of the reference samples comprises, if a plurality of reference samples are selected, selecting the plurality of reference samples so that a reference sample is not masked by a different reference sample.

According to another aspect of the present invention, there is provided a computer-readable recording medium having embodied thereon a program for executing the audio signal encoding method.

According to another aspect of the present invention, there is provided a method for decoding an audio signal, including: decoding one or more reference samples from data obtained by encoding samples of a frequency band which is a decoding unit; and decoding the remaining samples other than the decoded reference samples, among the samples of the frequency band, using a predetermined random function.

The decoding of the remaining samples includes: determining amplitudes of first type samples which are within a predetermined frequency range from the reference samples, using the predetermined random function, to be smaller than a predetermined ratio of amplitudes of the first type samples of the corresponding reference samples; and determining amplitudes of second type samples that are remaining samples other than the reference samples or the first type samples in the frequency band, using the predetermined random function, to be smaller than a predetermined value.

The determining of the amplitudes of the first type samples is performed with reference to information indicating the predetermined frequency range and the predetermined ratio, the determining of the amplitudes of the second type samples is performed with reference to information indicating the predetermined value, and the information indicating the predetermined frequency range and the predetermined ratio, and the information indicating the predetermined amplitude are extracted from the data.

The method further includes: extracting phase information from the data, wherein in the decoding of the remaining samples, a predetermined number of samples selected in descending order of amplitude from among the samples of the frequency band are determined with reference to the phase information.

According to another aspect of the present invention, there is provided a computer-readable recording medium having embodied thereon a program for executing the audio signal decoding method.

According to another aspect of the present invention, there is provided an apparatus for encoding an audio signal, including: a reference sample selecting unit which selects one or more reference samples including a sample whose amplitude is a maximum of all samples, from samples included in a frequency band which is an encoding unit; a determining unit which determines amplitudes of the remaining samples other than the reference samples, from among the samples included in the frequency band, using a predetermined random function; and an encoding unit which encodes the reference sample and the remaining samples whose amplitudes have been determined.

According to another aspect of the present invention, there is provided an apparatus of decoding an audio signal, including: a first decoder which decodes one or more reference samples from data obtained by encoding samples of a frequency band which is a decoding unit; and a second decoder which decodes the remaining samples other than the decoded reference sample, from among samples of the frequency band, using a predetermined random function.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram of a related art parametric encoding apparatus for encoding data at a low bit rate;

FIG. 2 is a view for explaining a method of encoding an audio signal according to an exemplary embodiment of the present invention;

FIG. 3 is a flowchart of a method of encoding an audio signal according to an exemplary embodiment of the present invention;

FIG. 4 is a view for explaining a method of selecting a reference sample according to an exemplary embodiment of the present invention;

FIG. 5 is a flowchart of a method of determining the amplitudes of the samples other than the reference sample according to an exemplary embodiment of the present invention;

FIG. 6 is a block diagram of an audio signal encoding apparatus according to an exemplary embodiment of the present invention;

FIG. 7 is a flowchart of a method of decoding an audio signal according to an exemplary embodiment of the present invention; and

FIG. 8 is a block diagram of an audio signal decoding apparatus according to an exemplary embodiment of the present invention.

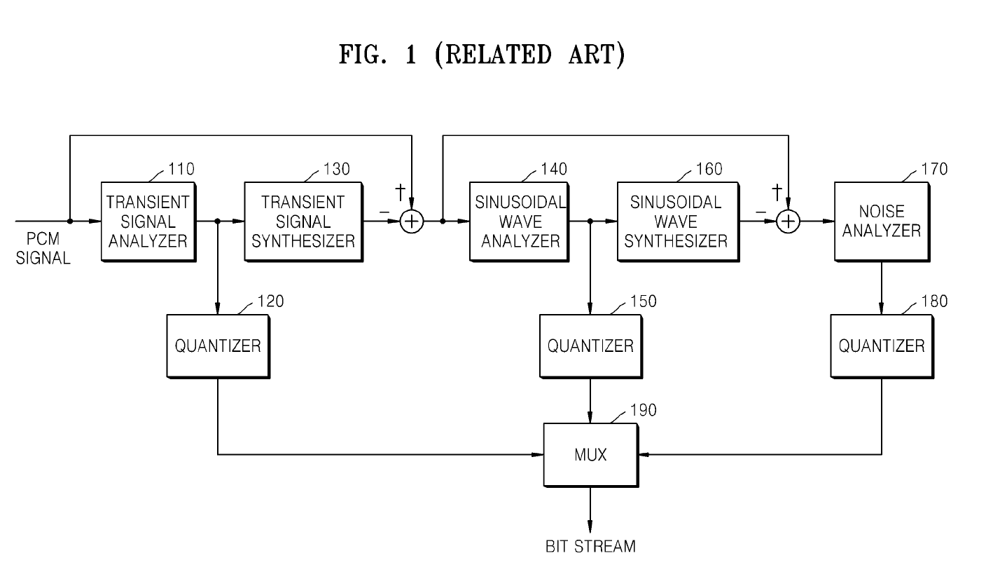

### DETAILED DESCRIPTION OF THE EXEMPLARY EMBODIMENTS OF THE INVENTION

Hereinafter, exemplary embodiments of the present invention will be described in detail with reference to the appended drawings.

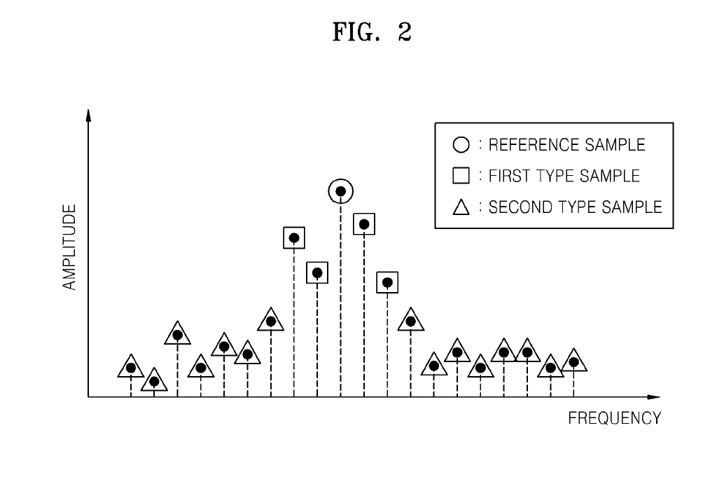

FIG. 2 is a view for explaining a method of encoding an audio signal, according to an exemplary embodiment of the present invention. In FIG. 2, frequency components (hereinafter, referred to as samples) in a frequency band, which is an encoding unit, of the audio signal are illustrated. The encoding unit depends on the codec used, and may be a frame or a sub-band.

In the encoding method, the reference sample having the greatest amplitude is selected and encoded, and the amplitudes of the remaining samples are determined using a random function. Accordingly, since the remaining samples other than the reference sample can be generated by an encoder using the same random function, the encoder encodes only the information required to generate the remaining samples using the random function, and accordingly can encode the audio signal at a low bit rate.

In the case of randomly determining the amplitudes of the remaining samples other than the reference sample, and then encoding and decoding the remaining samples, sound quality may deteriorate significantly. However, in the case where little tonal component exists or a lot of noise is generated, no significant difference in human perception occurs even though frequency components are randomly generated. Accordingly, the present invention can effectively encode and decode audio signals having a large amount of noise. The encoding method will now be described in more detail.

The encoder selects the sample having the greatest amplitude, as a reference sample, from among the frequency components of a received audio signal, and encodes index information, the amplitude, etc. of the reference sample. In the current exemplary embodiment, it is also possible, but not necessary, that a plurality of reference samples are selected, wherein the number of reference samples depends on the target bit rate. In FIG. 2, it is assumed that a single reference sample is selected.

If the reference sample is selected, peripheral samples of the reference sample are selected, and the amplitudes of the peripheral samples are determined using a random function. Hereinafter, the peripheral samples will be referred to as first type samples. The range of the first type samples with respect to the reference sample can be set arbitrarily or to an optimal value determined experimentally according to the characteristics of the audio signal. In the present invention, the “random function” is a function which outputs a predetermined pattern with respect to the same input value after being initialized. That is, if the encoder and decoder use the same random function, a value having the same pattern can be obtained.

The amplitudes of the first type samples are adjusted using the random function, but if the adjusted values are too great, humans may perceive signal distortion. Accordingly, it is necessary to limit the amplitudes of the first type samples to within a constant limit value. The amplitudes of the first type samples are preferably, but not necessarily, adjusted within a range which does not exceed the average of the first type samples.

The remaining samples (hereinafter, referred to as second type samples) other than the reference sample and the first type samples are also adjusted using the random function. At this time, it is also necessary to limit the amplitudes of the second type samples to a constant limit value. Also, the amplitudes of the second type samples are preferably, but not necessarily, adjusted to within a range which does not exceed the average of the second type samples.

If the amplitudes of all the samples other than the reference sample are adjusted, the audio signal can be encoded using information regarding the reference sample, the selection range of the first type samples, information regarding the maximum value of the first type samples, and information regarding the maximum value of the second type samples, and as a result the audio signal can be encoded at a low bit rate.

In order to improve sound quality, the audio signal can be encoded considering phase information. That is, some samples among the reference sample and the remaining samples whose amplitudes are adjusted, which have relatively high amplitudes, can be encoded considering the phase of the original audio signal. That is, phase information for some samples can be generated. In this case, it may be preferable that the phase information indicates whether the phase is positive (+) or negative (−), that is, whether the phase is a value from −π to 0 or a value from 0 to +π, instead of indicating the exact phase. Accordingly, the phase information can be represented using 1-bit information for each sample to aid encoding at a low bit rate.

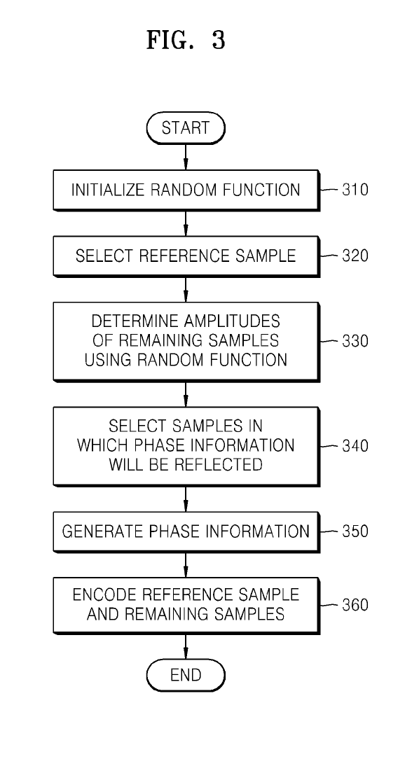

FIG. 3 is a flowchart of a method of encoding an audio signal, according to an exemplary embodiment of the present invention.

In operation 310, a random function is initialized.

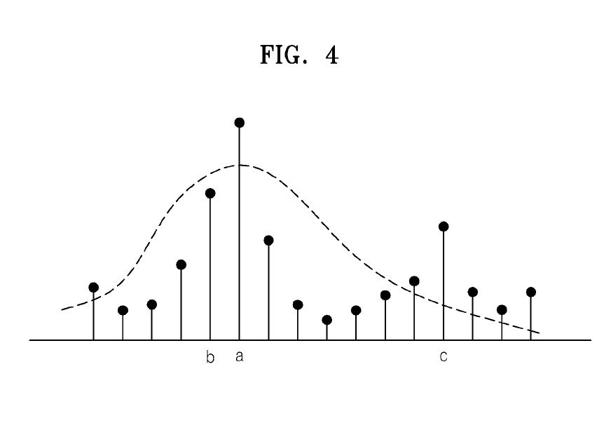

In operation 320, the sample having the greatest amplitude, among samples in a frequency band which is an encoding unit, is selected as a reference sample. Here, the number of reference samples which will be selected depends on the target bit rate. If a plurality of reference samples are selected, the reference samples are selected in descending order of amplitude in such a manner that a reference sample is not masked by another reference sample. The operation will be described in more detail with reference to FIG. 4.

In operation 330, the amplitudes of the remaining samples other than the reference sample are adjusted using the random function. Here, the remaining samples include first type samples and second type sample as described above.

In operation 340, samples for which phase information will be reflected are selected from among the reference sample and the remaining samples. The samples in which the phase information will be reflected are selected in descending order of amplitude, among the reference sample and the remaining samples.

In operation 350, the phase information, which is to be used for encoding, is generated. As described above, the phase information preferably indicates whether the phase is positive (+) or negative (−), instead of representing the exact phase of the original sample.

In operation 360, the reference sample and the remaining samples are encoded. For example, the reference sample can be encoded using the amplitude, index information, and phase of the reference sample, and the remaining samples can be encoded using the maximum value and selection range (the distance from the reference sample) of the first type samples, and the maximum value of the second type samples. Here, the maximum value of the first type samples and the maximum value of the second type samples indicate the maximum values of the samples whose amplitudes have been adjusted. The remaining samples also can be encoded considering phase information. In this case, although the bit rate increases, sound quality can be improved, as described above.

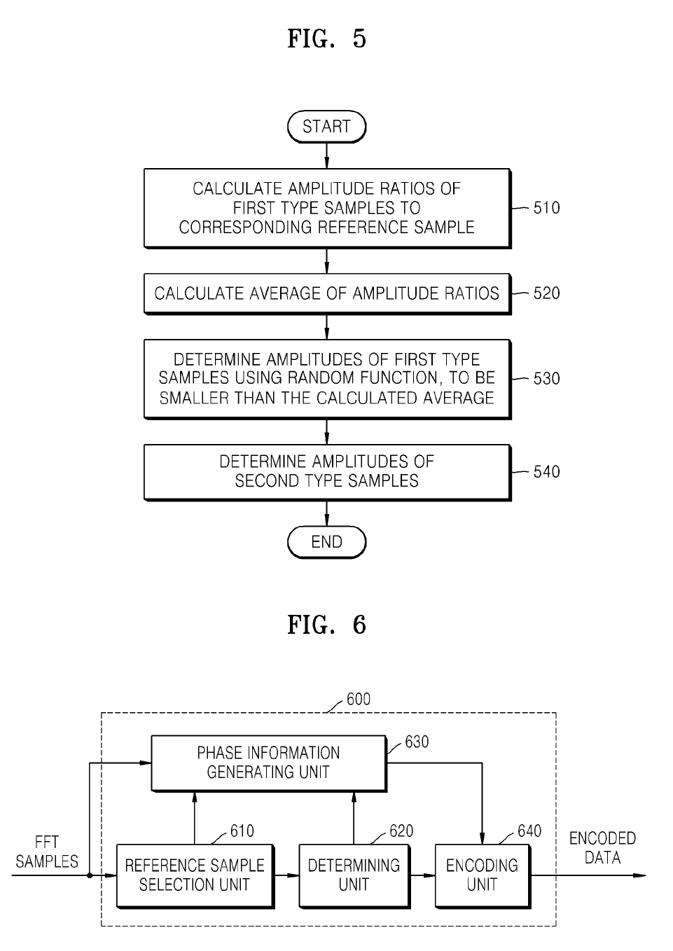

If a single reference sample is used, the maximum value of the first type samples is the average of the first type samples of the original audio signal. If a plurality of reference samples are used, the maximum value of the first type samples can be represented as a ratio to each corresponding reference sample. Details of this will be described later with reference to FIG. 5.

FIG. 4 is a view for explaining a method of selecting a reference sample, according to an exemplary embodiment of the present invention. In the current exemplary embodiment, it is assumed that two reference samples are selected in a frequency band illustrated in FIG. 4.

First, since the sample “a” has the greatest amplitude, it is selected as a reference sample. Then, a sample “b” having the second greatest amplitude is selected. However, since the sample “b” is masked by the sample “a” by psychoacoustics, and thus cannot be recognized by the human ear, encoding the amplitude of the sample “b” is meaningless. In FIG. 4, a masking curve of the sample “a” is denoted by a dotted line. Accordingly, a sample “c” having the greatest amplitude among samples which are not masked by the sample “a” is selected as a second reference sample.

FIG. 5 is a flowchart of a method of determining the amplitudes of the samples other than the reference sample according to an exemplary embodiment of the present invention. In the current exemplary embodiment, it is assumed that a plurality of reference samples exist.

In operation 510, an amplitude ratio of first type samples to corresponding reference samples is calculated. Here, the amplitudes of the first type samples may be set to the average of the actual amplitudes of the first type samples.

In operation 520, the average of all the amplitude ratios is calculated. For example, it is assumed that two reference samples exist. If the average of first type samples is 60% of the amplitude of the first reference sample, and the average of the first type samples is 80% of the amplitude of the second reference sample, the average value calculated in operation 520 is 70.

In operation 530, the amplitudes of the first type samples are adjusted according to a random function, using the calculated average as a maximum value. Strictly speaking, the amplitudes of the first samples are newly determined. In the current exemplary embodiment, if the average value is 70, the amplitudes of the first type samples corresponding to the first reference sample are determined by the random function, considering 70% of the amplitude of the first reference sample as a maximum, and the amplitudes of the second type samples corresponding to the second reference sample are determined by the random function, considering 70% of the amplitude of the second reference sample as a maximum.

In operation 540, the amplitudes of the second type samples are determined using the random function. At this time, likewise, a maximum of values output from the random function is set. Preferably, but not necessarily, the average of the second type samples of the original signal is set as the maximum.

FIG. 6 is a block diagram of an audio signal encoding apparatus according to an exemplary embodiment of the present invention.

Referring to FIG. 6, the audio signal encoding apparatus 600 includes a reference sample selection unit 610, a determining unit 620, a phase information generating unit 630, and an encoding unit 640.

If sample values in the frequency domain are input to the audio signal encoding apparatus 600, the reference sample selection unit 610 selects reference samples from among the sample values. The number of reference samples depends on the target bit rate. The reference samples are selected in descending order of amplitude in such a manner that a reference sample is not masked by a different reference sample.

The determining unit 620 adjusts the amplitudes of the samples (that is, first type samples and second type samples) other than the reference samples. The amplitudes of the first type samples are determined using a random function, within a range which does not exceed the average of the ratios of the amplitudes of the first type samples to the amplitude of each corresponding reference sample in the original signal. The amplitudes of the second type samples are determined within a range which is smaller than the average of the amplitudes of the second type samples in the original signal.

The phase information generating unit 630 selects a predetermined number of samples in descending order of amplitude, from among the reference sample and the remaining samples whose amplitudes have been adjusted, and generates phase information of the selected samples. As described above, for encoding at a low bit rate, it is preferable that the phase information indicates whether the phase value is positive (+) or negative (−).

The encoding unit 640 encodes the reference sample and the remaining samples. For example, the reference sample can be encoded according to its amplitude and index information. The first type samples can be encoded according to amplitude information, that is, maximum value information (that is, the average of amplitude ratios of the first type samples to the reference sample in an original signal) that is input to the random function, and a frequency range (a frequency distance from the reference sample). Also, the second type samples can be encoded to maximum value information (the average of the second type samples in the original signal) that is input to the random function.

As described above, the encoding unit 640 can encode some samples having relatively high amplitudes, considering phase information, in order to improve sound quality.

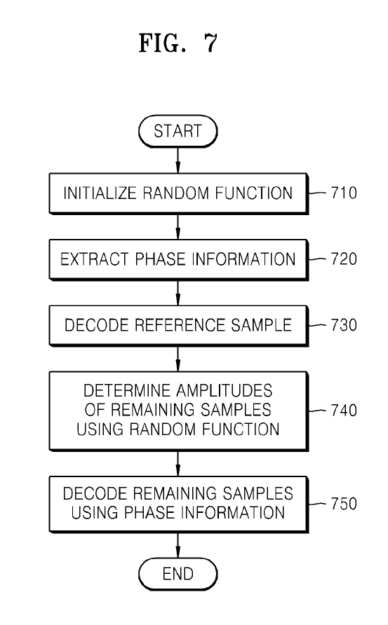

FIG. 7 is a flowchart of a method of decoding an audio signal, according to an exemplary embodiment of the present invention.

In operation 710, a random function is initialized. The random function is the same as the random function used in the encoder. By using the random function, the decoder can receive a maximum value used in an encoder, and can generate an output value having the same pattern as that used in the encoder.

In operation 720, phase information is extracted from encoded data. For example, if 8 pieces of phase information are extracted from encoded data, 8 samples selected in descending order of amplitude from among all samples within one decoding unit will be decoded with reference to the 8 pieces of phase information.

In operation 730, a reference sample is decoded. If at least one piece of phase information is extracted in operation 720, at least one reference sample is decoded with reference to the phase information.

In operation 740, the amplitudes of the remaining samples other than the reference sample are determined using a random function. That is, the maximum value of first type samples among the remaining samples is input to the random function, thereby determining the amplitudes of the first type samples. Also, the maximum value of second type samples among the remaining samples is input to the random function, thereby determining the amplitudes of the second type samples.

In operation 750, the remaining samples, that is, the first type samples and the second type samples, are decoded. If phase information of some of the remaining samples is included in the phase information extracted in operation 720, the remaining samples are decoded with reference to the phase information.

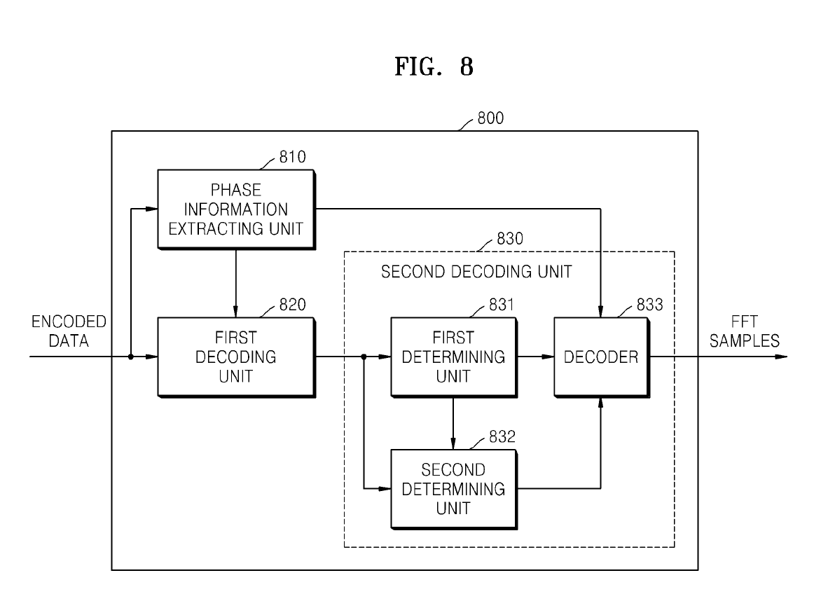

FIG. 8 is a block diagram of an audio signal decoding apparatus 800 according to an exemplary embodiment of the present invention. As illustrated in FIG. 8, the audio signal decoding apparatus 800 includes a phase information extracting unit 810, a first decoding unit 820, and a second decoding unit 830.

The phase information extracting unit 810 extracts phase information for samples from encoded data. Here, one-bit phase information is used for each sample so that the sign of a phase can be represented.

The first decoding unit 820 decodes a reference sample from the encoded data. At this time, the first decoding unit 820 can decode the reference sample with reference to the phase information.

The second decoding unit 830 decodes the samples other than the reference sample using a random function, and includes a first determining unit 831, a second determining unit 832, and a decoder 833.

The first determining unit 831 decodes first type samples which are peripheral samples of the reference sample. The first determining unit 831 extracts maximum value information of the first type samples from encoded data, and inputs the maximum value information to the random function, thus determining the amplitudes of the first type samples.

The second determining unit 832 extracts maximum value information of the amplitudes of second type samples from the encoded data, and inputs the maximum value information to the random function, thus determining the amplitudes of the second type samples.

The decoder 833 decodes the first type samples and the second type samples, with reference to the amplitude information determined by the first determining unit 831 and the second determining unit 832. At this time, the decoder 833 can decode the first type samples and the second type samples, with reference to the amplitude information and phase information. For example, if the phase information extracting unit 810 extracts 8 bits of phase information from encoded data, the decoder 833 applies phase information to 8 samples selected in descending order of amplitude from among the remaining samples, thus decoding the remaining samples.

The exemplary embodiments of the present invention can be written as computer programs and can be implemented in general-use digital computers that execute the programs using a computer readable recording medium. Examples of the computer readable recording medium include magnetic storage media (e.g. ROM, floppy disks, hard disks, etc.), optical recording media (e.g. CD-ROMs, or DVDs), and other storage media.

As described above, according to the present invention, when an audio signal having a large amount of noise is encoded, by considering some components of the audio signal as noise and determining their amplitudes using a random function, it is possible to encode and decode the audio signal at a low bit rate.

While the present invention has been particularly shown and described with reference to exemplary embodiments thereof, it will be understood by those of ordinary skill in the art that various changes in form and detail may be made therein without departing from the spirit and scope of the present invention as defined by the following claims.

What is claimed is:

1. A method of encoding an audio signal, the method comprising:
selecting at least one reference sample including a sample whose amplitude is a maximum of all samples, in a frequency band;
determining amplitudes of remaining samples other than the at least one reference sample in the frequency band, using a random function; and
encoding the at least one reference sample and the remaining samples whose amplitudes have been determined.

2. The method of claim 1, wherein the determining the amplitudes of the remaining samples comprises:
determining amplitudes of first samples which are within a frequency range from the at least one reference sample, using the random function, to be smaller than a ratio of the amplitudes of the corresponding at least one reference sample; and
determining amplitudes of second samples that are the remaining samples other than the at least one reference sample or the first samples, using the random function, to be smaller than an average of amplitudes of the second samples.

3. The method of claim 2, wherein in the encoding the at least one reference sample and the remaining samples, the first samples are encoded according to information indicating the ratio and the frequency range, and the second samples are encoded according to information indicating the average value of the amplitudes of the second samples.

4. The method of claim 2, wherein the ratio is an average of ratios of the amplitudes of the first samples to the amplitude of the corresponding at least one reference sample.

5. The method of claim 1, further comprising:
selecting a predetermined number of samples in descending order of amplitude, from among the at least one reference sample and the remaining samples; and
generating information regarding phases of the predetermined number of samples,
wherein the encoding the at least one reference sample and the remaining samples is performed according to the information.

6. The method of claim 5, wherein the information indicates whether phases of original samples corresponding to the predetermined number of samples are positive or negative.

7. The method of claim 1, wherein the selecting the at least one reference sample comprises selecting the at least one reference sample in descending order of amplitude, from samples included in the frequency band, and varying a number of reference samples that are to be selected according to a bit rate.

8. The method of claim 7, wherein the selecting the at least one reference samples comprises, if a plurality of reference samples are selected, selecting the plurality of reference samples so that a reference sample is not masked by another reference sample.

9. A computer-readable recording medium having embodied thereon a program for executing the method of claim 1.

10. A method for decoding an audio signal, the method comprising:
decoding at least one or reference sample from data obtained by encoding samples of a frequency band; and
decoding remaining samples other than the at least one reference sample, among the samples of the frequency band, using a random function.

11. The method of claim 10, wherein the decoding the remaining samples comprises:
determining amplitudes of first samples which are within a frequency range from the at least one reference sample, using the random function, to be smaller than a ratio of amplitudes of the first samples of the corresponding at least one reference sample; and
determining amplitudes of second samples that are remaining samples other than the reference samples or the first samples in the frequency band, using the random function, to be smaller than a predetermined value.

12. The method of claim 11, wherein the determining the amplitudes of the first type is performed with reference to information indicating the frequency range and the ratio,
the determining the amplitudes of the second samples is performed with reference to information indicating the predetermined value, and
the information indicating the frequency range and the ratio, and the information indicating the amplitude are extracted from the data.

13. The method of claim 10, further comprising:
extracting phase information from the data,
wherein in the decoding the remaining samples, a number of samples selected in descending order of amplitude from among the samples of the frequency band are determined with reference to the phase information.

14. The method of claim 13, wherein the information indicating the phase indicates whether phases of original samples corresponding to the number of samples are negative or positive.

15. A computer-readable recording medium having embodied thereon a program for executing the method of claim 10.

16. An apparatus for encoding an audio signal, the apparatus comprising:
a reference sample selecting unit which selects at least one reference sample including a sample whose amplitude is a maximum of all samples, from samples included in a frequency band;
a determining unit which determines amplitudes of remaining samples other than the at least one reference sample, from among the samples included in the frequency band, using a random function; and
an encoding unit which encodes the at least one reference sample and the remaining samples whose amplitudes have been determined.

17. The apparatus of claim 16, wherein the determining unit determines amplitudes of first samples which are within a frequency range from the at least one reference sample, using the random function, to be smaller than a ratio of the amplitude of the corresponding reference sample; and
determines amplitudes of second samples that are remaining samples other than the reference samples or the first samples, using the random function, to be smaller than an average of original amplitudes of the second samples.

18. The apparatus of claim 17, wherein the encoding unit encodes the first samples according to information indicating the ratio and the frequency range, and encodes the second samples according to information indicating an average value of the amplitudes of the second samples.

19. The apparatus of claim 17, wherein the ratio is an average of ratios of original amplitudes of the first samples to the amplitude of the corresponding at least one reference sample.

20. The apparatus of claim 16, further comprising:
a phase information generator which selects a number of samples in descending order of amplitude, from among the at least one reference sample and the remaining samples, and which generates information regarding phases of the number of samples, wherein
the encoding unit which encodes considering the generated information.

21. The apparatus of claim 20, wherein the information indicates whether phases of original samples corresponding to the number of samples are negative or positive.

22. The apparatus of claim 16, wherein the reference sample selecting unit selects the at least one reference sample in descending order of amplitude, from the samples included in the frequency band, and varies a number of reference samples that are to be selected according to a target bit rate.

23. The apparatus of claim 22, wherein if a plurality of reference samples are selected, the reference sample generator selects the plurality of reference samples so that a reference sample is not masked by another reference sample.

24. An apparatus of decoding an audio signal, comprising:
a first decoder which decodes at least one reference sample from data obtained by encoding samples of a frequency band; and
a second decoder which decodes remaining samples other than the at least one reference sample, from among samples of the frequency band, using a random function.

25. The apparatus of claim 24, wherein the second decoder comprises:
a first determining unit which determines amplitudes of first samples which are within a frequency range from the at least one reference sample, using the random function, to be smaller than a ratio of amplitudes of the corresponding reference samples; and
a second determining unit which determines amplitudes of second samples that are remaining samples other than the at least one reference sample or the first samples using the random function, to be smaller than a predetermined value.

26. The apparatus of claim 25, wherein the first determining unit decodes the first samples with reference to information indicating the frequency range and the ratio,
the second determining unit decodes the second samples with reference to information indicating the amplitude, and
the information indicating the frequency range and the ratio, and the information indicating the amplitude are extracted from the data.

27. The apparatus of claim 24, further comprising a phase information extracting unit which extracts phase information from the data, wherein the first decoding unit and the second decoding unit decode the number of samples selected in descending order of amplitude from among samples of the frequency band according to the extracted phase information.

28. The apparatus of claim 27, wherein the phase information indicates whether phases of the number of samples are negative or positive.
